(19) United States
(12) Patent Application Publication
(10) Pub. No.: US 2025/0047052 A1
(43) Pub. Date: Feb. 6, 2025

(54) Tool and cable connection device comprising same

(71) Applicant: HARTING Electric Stiftung & Co. KG, Espelkamp (DE)

(72) Inventors: Luca BALTRUSCHAT, Minden (DE); Christof HERMONI, Rahden (DE); Markus WITTPAHL, Hüllhorst (DE); Jan Andree BENEKE, Vechta (DE); Norbert KROPIEWNICKI, Bielefeld (DE); Sergej ZIER, Löhne (DE)

(73) Assignee: HARTING Electric Stiftung & Co. KG, Espelkamp (DE)

(21) Appl. No.: 18/717,546

(22) PCT Filed: Dec. 20, 2022
(86) PCT No.: PCT/DE2022/100971

§ 371 Date: Jun. 7, 2024

(30) Foreign Application Priority Data
Jan. 10, 2022 (DE) 10 2022 100 405.8

(51) Int. Cl. H01R 43/26; H01R 4/48

(52) U.S. Cl. CPC H01R 43/26; H01R 4/4833; H01R 4/48365

(57) ABSTRACT

A tool (8) for locking an actuator (3) which is longitudinally movable, counter to the spring pressure of a spring element, in a guide channel (1) of an insulating housing between an unloaded and an actuated position, includes: means for releasably fastening the tool (8) to the insulating housing; a drive element for moving the actuator (3) into its actuated position; and means for locking the actuator (3) in this position.

### CROSS-REFERENCE TO RELATED APPLICATION

This application is a national stage application, filed under 35 U.S.C. § 371, of International Patent Application PCT/DE2022/100971, filed on Dec. 20, 2022, which claims the benefit of German Patent Application DE 10 2022 100 405.8, filed on Jan. 10, 2022.

### TECHNICAL FIELD

The disclosure relates to a tool, an insulating housing and a cable connection device.

### BACKGROUND

Firstly, a cable connection device in an insulating housing generally has a contact carrier with a conductor rail. Secondly, a spring-elastic contact arm is generally provided for fixing an electrical conductor to the conductor rail. To this end, the electrical conductor is clampingly fixed between the conductor rail and the contact arm. The contact arm acts as a clamping arm or clamping limb. The term “contact arm” which is selected here is intended to mean that the clamping force of the contact arm has to be applied to the electrical conductor in order to produce the permanent electrical contact of the conductor with the conductor rail. An actuator cooperating with the contact arm serves for actuating the contact arm.

To this end, the actuator is mounted in a guide channel in the contact carrier so as to be displaceable between an unloaded position and an actuated position. In principle, the cable connection device serves to press an electrical conductor, for example a wire, in particular a stranded wire of an electrical conductor inserted into the contact carrier, with the contact arm against the conductor rail and thus to connect it to the conductor rail in an electrically conductive manner and at the same time to hold it mechanically on the conductor rail. Generally in the so-called “push-in” technique it is sufficient simply to plug the electrical conductor into a cable insertion opening on the contact carrier so that it is pushed between the contact arm, preferably a clamping limb of a preferably V-shaped clamping spring, and a contact portion of the conductor rail and is clampingly fixed between the contact arm and the contact portion of the conductor rail against being pulled out counter to its insertion direction. This “push-in” connecting technique is particularly user-friendly since the manual effort is very small and it can be carried out in a simple manner by the operator using two hands. The actuator thus serves merely for releasing the connection, if there is a corresponding need, by pushing down the contact arm.

However, this method requires a sufficiently rigid and stable electrical conductor. The individual wires of the stranded wire have to be, for example, numerous and/or sufficiently stiff or the stranded wire has to be provided with a wire end ferrule, for example. The wire can be also a single, relatively stiff solid conductor. If, however, in exceptional cases a less stiff wire, for example a thin stranded wire without a wire end ferrule, is pushed in, it can arise that it is not able to move, in particular to bend, the contact arm away from the contact portion of the conductor rail. In this case, the actuator already has a second function when the connection is produced between the conductor and the conductor rail, in which the actuator moves the contact arm away from the contact portion of the conductor rail in its actuated position, in order for this thin wire to be able to be pushed in at all. If the actuator is now released again, this thin wire can also be clamped by the contact arm on the contact portion of the conductor rail and electrically conductively connected, and secured against being inadvertently pulled out. However, this is very uncomfortable to perform with two hands since the contact carrier and the cable have to be held and the actuator has to be actuated at the same time.

It is disclosed in DE 10 2017 127 001 B3 and DE 10 2008 039 232 B4 to modify structurally the actuator or to supplement the actuator with additional parts, in order to lock the actuator in its actuated position. Due to this locking, therefore, the contact carrier can be held with one hand and the wire or the cable end can be inserted with the other hand. In this inserted position of the wire or the cable end, the contact carrier and the inserted cable can be easily held with one hand and the locking body unlocked again, so that the actuator releases the contact arm and the contact closes automatically. This has the drawback, however, that on the one hand structural changes are required on the actuator and these changes usually require installation space which is generally not available.

The German Patent and Trademark Office has researched the documents DE 10 2018 102 706 A1 and DE 10 2015 120 063 B3 for the priority-claiming application.

DE 10 2018 102 706 A1 describes that a spring force of a clamping spring is exerted on an actuating tool via an actuator. Via this force which is exerted by the clamping spring, the actuating tool is pushed into a fixing means which is configured as a recess.

### SUMMARY

The present application discloses a locking means for the actuator which takes up as little installation space as possible. At the same time, the locking means for the actuator is intended to require as few structural changes as possible, in particular to the cable connection device. Finally, the locking means is to be made possible without the force of the clamping spring acting on the actuator.

This object is achieved by the tool as claimed in claim 1, the insulating housing as claimed in claim 14 and the cable connection device as claimed in claim 17. Preferred embodiments are defined in the dependent claims.

The disclosure is based on the fundamental consideration of leaving the actuator for the cable connection device unchanged. This ensures both optimal stability and simple handling of the actuator. Since in the vast majority of applications a cable connection is possible in a simple manner by simply plugging the electrical conductor into the contact carrier according to the “push-in” technique, in the illustrated case the actuator has to be held pushed-down in order to be able to insert a non-dimensionally stable wire, in a rare special case.

The disclosure thus takes a different path from modifying the actuator, which is structurally complex. A tool which has means for releasably fixing to the insulating housing is proposed. Moreover, the tool has a drive element for moving the actuator into its actuated position. Furthermore, the drive element locks the actuator in this actuated position in order to be able to undertake the required operations. Then the tool is removed again from the insulating housing.

This external tool firstly has the advantage that it requires no additional installation space in the guide channel of the actuator in the insulating housing. Secondly, it is advantageous that the operator of the tool has to be familiar only with the longitudinal displaceability of the actuator, which is known in any case, and the operation of the tool. In contrast, the operator does not have to have any knowledge of special devices on the actuator for the locking thereof in the actuated position, as in the prior art. The tool is thus able to be used universally and also does not require any detailed product knowledge on the part of the operator.

The tool itself generates the force by which the means for releasable fastening are releasably fastened to the insulating housing. This prevents the insulating housing, the actuator and/or a clamping spring, which is operatively connected to the actuator, from having to apply the force for fastening the tool. This in turn makes it possible for there to be no requirements for restoring forces exerted by the clamping spring, for example. Even with very small or fluctuating restoring forces of the clamping spring, a secure and reliable fastening in the insulating housing, in particular in the guide channel, is accordingly ensured by the tool.

To this end, the tool has force-generating means which are configured to apply a force which is required for fastening the means for releasable fastening in the insulating housing. In the embodiments described below, for implementing the force-generating means it is possible to conceive of many different options which all have in common that the means for releasable fastening are fastened by the tool itself and not by the insulating housing or a part thereof. The force of the actuator acts against the drive element, i.e. along the guide channel, but not in the operating direction of the means for releasable fastening. The effective fastening thus does not depend on the force of the actuator. Thus it is sufficient if the force of the actuator is just sufficient to move itself out of the actuated position.

The insulating housing is preferably an insulating housing of a plug connector part or a plug connector insert. Relative to other insulating housings, such as for example conductor terminals mounted on top hat rails, plug connector parts are generally not fixed in position so that in a cable connection the plug connector part has to be held securely with one hand, which requires another free hand for the cable connection. In the case of conductor terminals, however, it is possible for both hands to be available for the cable connection. Accordingly, the cable connection which is simplified by the tool is particularly advantageous, in particular, for plug connectors and, in particular, for plug connector modular systems.

The tool is expediently configured such that, in its position fixed to the insulating housing, it fixes the actuator in its actuated position at the same time. Thus it is clear to the operator that, when the tool is fixed, the actuator has released the contact arm from the conductor rail, so that an attached conductor can be removed or a conductor to be connected can be attached.

In an advantageous embodiment, at least one undercut is configured on the inner wall of the channel, rear engagement parts which are configured on the tool being able to engage in said at least one undercut. Generally such undercuts are present in any case on the inner wall of the guide channel, since in its unloaded position the actuator requires a stop in order not to fall out of the insulating housing in its unloaded position when the contact is closed. Thus an undercut, for example a bottle neck-like constriction, at the end of the guide channel and against which the actuator strikes with a shoulder, serves as a stop. This undercut can be used at the same time for the rear engagement, for the releasable fastening of the tool.

In a first embodiment, the tool has a locking plate which is rotatable about its tool longitudinal axis. The actuator is moved into its actuated position in the guide channel of the insulating housing by this locking plate or a projection protruding from the locking plate in the direction of the upper end of the actuator. If the locking plate is pivoted about the tool longitudinal axis in this actuated position of the actuator, the plate ends engaging behind the undercut in the guide channel form the rear engagement with this undercut. The actuator pushes from below onto the plate and in this manner pushes the plate ends against the undercuts. The tool is thus locked in the guide channel and holds the actuator in its actuated position. For releasing the connection, the locking plate has to be pivoted back again into its initial position in which it can move in the guide channel in the direction of the tool longitudinal axis.

A further embodiment firstly has a rigid lever as a drive element and two latching arms which oppose one another and which preferably flank the lever on both sides. The latching arms are movable transversely to the tool longitudinal axis and at their free ends have latching projections. The central rigid lever extending in the direction of the tool longitudinal axis, as a drive element, pushes the operator into its actuated position. In this actuated position, the latching arms engage with their latching projections at their free ends in the already mentioned undercuts on the inner wall of the guide channel. If the pressure from the lever on the actuator is released, the actuator pushes from below onto the lever of the tool and thus pushes the latching projections from below against the undercuts. The tool is thus locked in the guide channel and holds the actuator in its actuated position.

In one embodiment, the drive element is designed as a central lever. In other embodiments, the lever is designed as a hollow body, in particular as a cylindrical hollow body, wherein preferably the latching arms and the latching projections can then be received inside the hollow body.

In a further embodiment, these latching arms are configured as spring arms which are resilient transversely to the tool longitudinal axis and which have latching projections configured as latching hooks at their free ends. In this embodiment, the tool is inserted into the guide channel of the actuator, wherein the latching hooks slide down the inner walls of the guide channel, while the central rigid lever moves the actuator into its actuated position. As soon as this actuated position of the actuator is reached, the spring arms spring out and the latching hooks form with the undercuts an automatically closing snap connection. Expediently, the ends of the latching hooks facing away from the spring arms are provided with insertion bevels which optimizes the movement of the tool in the guide channel. If the pressure from the lever on the actuator is released, the actuator in turn pushes from below onto the lever of the tool and thus pushes the latching projections from below against the undercuts. In this embodiment, the tool is also locked in the guide channel and holds the actuator in its actuated position.

In a development of this embodiment, a guide ring which can be moved on the outer surfaces of the spring arms in the direction of the latching hooks is provided. This guide ring has an inner contour which slides on the outer surfaces of the spring arms. If the guide ring is moved in the direction of the latching hooks of the spring arms, the inner contour pushes the spring arms against the lever of the tool and moves the latching hooks into their open position, i.e. opens the rear engagement. If the guide ring is moved upwardly from the latching hooks on the spring arms, however, the spring arms spring out and the latching hooks can move back again automatically into the undercuts on the inner wall of the guide channel. The guide ring thus serves to move the spring arms, which are configured in an elastically resilient manner, from their closed position in which the latching hooks engage behind the undercuts in the inner wall of the guide channel of the actuator into an open position in which the spring arms bear against the rigid lever, in order to be able to remove the tool again safely from the guide channel. It is also possible to design the rigid central lever as a hollow profile such that the spring arms and, in particular the latching hooks on the end side thereof, in the closed position of the guide ring are inserted in the hollow profile, i.e. are retracted into the hollow profile.

In a further embodiment of the tool, a handle is provided on the tool. This handle is preferably cylindrical. A longitudinally displaceable unlocking sleeve is arranged in a hollow space in the handle. The guide ring is a constituent part of this unlocking sleeve. The guide ring forms the lower end of the unlocking sleeve.

The actual tool with the rigid central lever and the two spring arms is also arranged at the lower end of the unlocking sleeve. The upper end of the tool handle has a button which is coupled to the unlocking sleeve. The button is mounted in the tool handle so as to be longitudinally displaceable in the direction of the tool longitudinal axis. If the button is pushed into the tool handle, the guide ring at the lower end of the unlocking sleeve moves into its closed position, so that the spring arms spring in and bear against the lever or lie within the hollow profile of the lever. Thus the tool can be released in a simple manner from the rear engagement by means of the button on the handle.

Since the button is moved into the tool handle counter to the spring pressure of a compression spring, the button automatically moves back into its initial position when it is released. The button also pulls the unlocking sleeve back up into the initial position, whereby the spring arms spring out again in the open position of the guide ring remote from the latching hooks. The tool, which is reminiscent of a ballpoint pen in terms of its appearance, can then simply be reinserted into a guide channel of an insulating housing, wherein the latching hooks at the end of the spring arms slide down the inner walls of the guide channel and automatically snap back with the undercut in the actuated position of the actuator. In these embodiments with a guide ring, unlocking sleeve and handle it also applies that the actuator pushes from below with its restoring force onto the lever of the tool and thus pushes the latching projections from below against the undercuts in order to lock the tool in the guide channel and to hold the actuator in its actuated position.

In a further embodiment, the central lever is rotatably mounted about the tool longitudinal axis. Two opposing expansion cams protrude from the lateral surface of the lever. By rotating the lever, these expansion cams engage below the latching arms and move transversely to the tool longitudinal axis. In this embodiment, the actuator is moved in turn into its actuated position by the lever. Then the lever is rotated such that the expansion cams spread apart the latching arms, so that the latching arms engage in turn with their latching projections at their ends in the undercuts on the inner wall of the guide channel to form the rear engagement. The tool is locked in turn in the guide channel by the restoring force of the actuator in the manner described above.

The same effect can be produced by a modified variant of this embodiment. A longitudinally displaceable lever is combined with cranked latching arms. The lever engages below or behind the cranked portions on the latching arms when the lever is pushed in the direction of the actuator and thus, in the manner of the expansion cams, the cranked portions spread apart the latching arms transversely to the tool longitudinal axis, so that the latching arms engage in turn with their latching projections at their ends in the undercuts on the inner wall of the guide channel to form the rear engagement. The tool is locked in turn in the guide channel by the restoring force of the actuator in the manner described above.

Finally, an embodiment of the tool whose operation is similar to that of scissors or pliers is proposed. To this end, the latching arms have in each case an arcuate gripping arm, preferably with an opposing grip recess, at their ends facing away from the latching projections. The respective gripping arm faces in the transverse direction, in the opposing direction of the associated latching projection on the respective latching arm. Both latching arms are mounted on the tool by a rotary joint and are pivotably connected together via the rotary joint. The latching arms and the rotary joint together form a scissors lever which is actuated by the gripping arms.

Arcuate and leaf spring-like spring bodies protrude from the lever in the transverse direction, said spring bodies being adapted in terms of their arcuate shape to the arcuate shape of the gripping arms such that the spring bodies nestle with their outer wall against the inner wall of the gripping arms. If the tool is to be actuated, the gripping arms are pivoted toward one another in the transverse direction counter to the spring pressure of the leaf spring-like spring bodies, whereby the latching arms can also move toward one another in the transverse direction until they bear flush against the lever. If the grip of the operator is released, the spring bodies automatically move both the gripping arms and the latching arms back into their initial position.

The insulating housing has a contact carrier with a wire insertion opening, a conductor rail arranged in the wire insertion opening, and a clamping limb of a contact spring which applies spring pressure to the conductor rail. Moreover, the insulating housing has a guide channel for an actuator which is longitudinally displaceable counter to the spring pressure of the clamping limb between an unloaded and an actuated position for closing and opening the spring contact. Moreover, at least one undercut is configured on the inner wall of the guide channel, said undercut being able to fulfill the dual function of a stop for the actuator in its unloaded position and a rear engagement for the tool on the insulating housing.

In an advantageous embodiment, this undercut can be formed in the manner of a bottle neck by a housing opening constricting the remaining guide channel at the end of the guide channel. The actuator strikes against this constriction with corresponding contact shoulders.

It is also possible, however, to provide the inner wall of the guide channel with recesses and/or interruptions in order to form undercuts in the guide channel.

The contact connection achieves the object set forth in a manner according to the disclosure.

The invention is described in more detail with reference to exemplary embodiments shown in the figures of the drawing.

### BRIEF DESCRIPTION OF THE DRAWINGS

FIG. 1 shows the upper end of a guide channel with a constriction,

FIG. 2 shows the upper end of a guide channel with recesses,

FIG. 3 shows a mixed form of the upper ends of the guide channel from FIG. 1 and FIG. 2,

FIG. 4 shows the upper end of a guide channel with an actuator in its unloaded position with a tool held thereby,

FIG. 5 shows the upper end of a guide channel with an actuator moved by the tool into its actuated position,

FIG. 6 shows the view of FIG. 5 with the tool locked by the restoring force of the actuator in the guide channel,

FIG. 7 shows a first embodiment of the tool with the locking plate,

FIG. 8 shows a detailed view of the locking plate of FIG. 7,

FIG. 9 shows a sectional view of the locking plate inserted into the guide channel,

FIG. 10 shows a view from below of the locking plate without engagement in the undercut in the guide channel,

FIG. 11 shows a sectional view of the locking plate inserted into the guide channel with engagement in the undercut in the guide channel,

FIG. 12 shows a view from below of the locking plate with engagement in the undercut in the guide channel,

FIG. 13 shows a second embodiment of the tool with expansion cams,

FIG. 14 shows a detailed view of the tool of FIG. 13 with latching arms bearing against the lever,

FIG. 15 shows a detailed view of the tool of FIG. 14 with the latching arms spread apart,

FIG. 16 shows a modification of the second embodiment of the tool with expansion cams integrally formed in the latching arms,

FIG. 17 shows a third tweezer-like embodiment of the tool for a snap connection in the guide channel,

FIG. 18 shows a perspective view of the tool of FIG. 17 partially with enlarged details,

FIG. 19 shows the tool of FIG. 17 with the spring arms compressed,

FIG. 20 shows a modified design of the tool of FIG. 17,

FIG. 21 shows a detailed view of the end of the lever on the tool,

FIG. 22 shows a detailed view of a modified end of the tool,

FIG. 23 shows a fourth embodiment of the tool configured in the manner of a ballpoint pen with the unloaded compression spring,

FIG. 24 shows the tool of FIG. 23 with the button pushed in and the compression spring compressed,

FIG. 25 shows a detailed view of the lower end of the tool with the spring arms 10′ and the latching hooks 11′ of FIG. 23,

FIG. 26 shows a detailed view of the lower end of the tool with the spring arms and the latching hooks of FIG. 24,

FIG. 27 shows a fifth embodiment of the tool configured in the manner of scissors or pliers with unloaded spring bodies,

FIG. 28 shows a modified design of the tool of FIG. 17 with the handle and

FIG. 29 shows a further modified design of the tool of FIG. 17 with an alternative handle.

### DETAILED DESCRIPTION

The figures contain partially simplified, schematic views. Identical reference signs are used for identical and structurally identical parts. Different views of the same parts can be scaled differently.

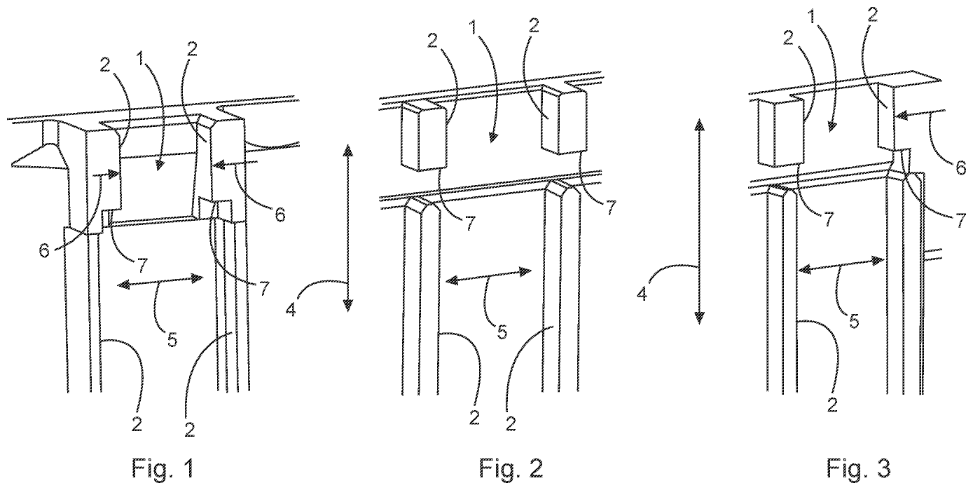

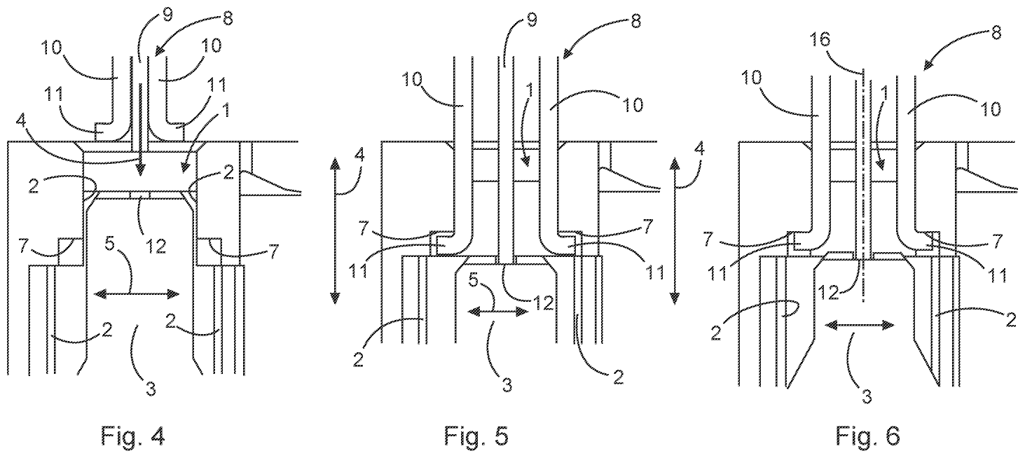

FIG. 1 shows the upper end of a guide channel 1. An actuator 3, shown first in FIG. 4, is mounted so as to be displaceable in the longitudinal direction 4 on the inner walls 2. In the view of FIG. 1 it can also be identified that the spacing between the inner walls 2 in the transverse direction 5 running at right-angles to the longitudinal direction 4 is significantly smaller at the upper end of the guide channel 1 than in the region of the guide channel 1 therebelow. The guide channel 1 has a bottle neck-like constriction 6 at its insertion opening. Undercuts 7 are formed in this manner in the transition from this constriction 6 to the region of the guide channel 1 where there is a greater transverse spacing of the inner walls 2.

FIG. 2 shows once again a guide channel 1 extending in the longitudinal direction 4. In this exemplary embodiment, the transverse spacing of the inner walls 2 is always the same in the transverse direction 5. The inner walls are interrupted in the region of the insertion opening of the guide channel 1 in order to create undercuts 7. In this manner, recesses are left in the inner walls 2 on both sides of the guide channel 1, the upper termination thereof in each case forming an undercut 7.

FIG. 3 discloses a mixed form of the design of the insertion opening of the guide channel 1 from the two exemplary embodiments described above. The left-hand inner wall 2 in FIG. 3 is perforated in order to create an undercut 7. The right-hand region of the inner wall 2 in turn has a constriction 6 in order to create an undercut 7.

The functional principle of the invention is explained by way of FIG. 4, FIG. 5 and FIG. 6.

The actuator 3 is shown in FIG. 4 in its unloaded initial position in the guide channel 1. FIG. 4, FIG. 5 and FIG. 6 show in each case the upper end of the guide channel 1 and the actuator 3. With its lower end, which is not shown in the drawings, the actuator 3 acts on a clamping limb of a contact spring, not shown in the drawings, for opening and closing the contact formed by the conductor rail, also not shown. In FIG. 4 the lower end of a tool 8 can be seen for moving the actuator 3 downwardly in the guide channel 1 in the longitudinal direction 4. The tool 8 has a central rigid lever 9 and two latching arms 10 which in each case laterally flank the rigid lever 9 and which have latching projections 11 at their free ends. In FIG. 4 a tool driving means 12 can also be identified in the top surface of the actuator 3. In FIG. 4 the latching arms 10 bear closely against the lever 9 so that the extent of the tool 8 including the latching projections 11 is smaller in the transverse direction 5 than the transverse spacing of the inner walls 2 of the guide channel 1. The tool 8 can thus be pushed into the guide channel 1 in the longitudinal direction 4. After the tool 8 is pushed into the guide channel 1, initially the end of the lever 9 facing the actuator 3 pushes against the top surface of the actuator 3 and at the same time acts on the tool driving means 12 of the actuator 3. The actuator 3 is pushed down by the lever 9 in the longitudinal direction 4 until it has reached its actuated position shown in FIG. 5. The clamping limb of the contact spring, not shown, is opened in this actuated position of the actuator 3.

It is clear, therefore, that the actuator 3 or the tool driving means 12 thereof cooperates only with the lever 9 and not with the latching arms 10 and thus the means for fastening the tool 8 to the insulating housing. The force of the actuator 3 can be very small since the fastening of the tool 8 is not influenced thereby. This is because the tool 8 itself has force-generating means which bring about the latching of the latching projections 11 of the latching arms 10 in the guide channel 1. This provides, in particular, structural advantages relative to alternatives in which the actuator brings about the latching, since the tool 8 can be securely fastened in the guide channel 1 automatically and without being dependent on the actuator 3.

The dimensions of the lever 9 and the latching arms 10 are adapted to one another such that, precisely in this actuated position of the actuator 3, the latching arms 10 engage with their latching projections 11 in recesses in the inner wall 2 and thus engage behind the undercuts 7 set forth above. FIG. 5 shows precisely this moment in which the actuator 3 is pushed down fully in the longitudinal direction 4 into its actuated position and the latching projections 11 of the latching arms 10 engage behind the undercuts 7 in the manner of snap hooks.

If the operator now releases the tool 8, the actuator 3 is pushed upwardly by the spring force of the clamping limb of the contact spring, not shown, in the longitudinal direction 4 and thus pushes the tool 8 with the latching projections 11 of the latching arms 10 against the undercuts 7, such that the tool 8 is fastened by the restoring force of the actuator 3 so as to be locked in the guide channel 1.

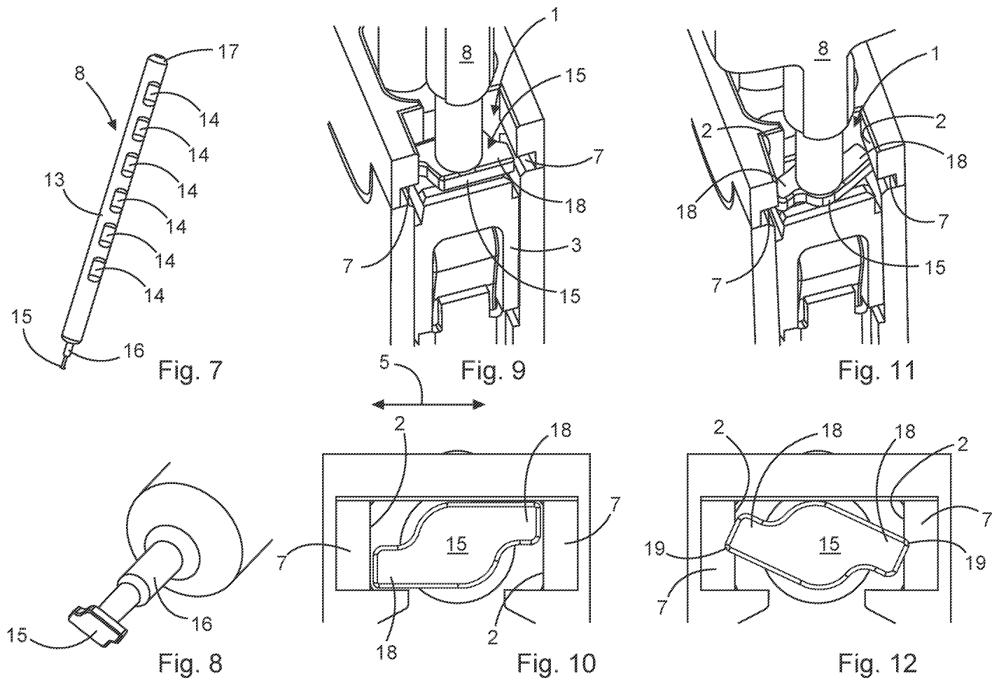

FIG. 7 shows a first embodiment of the tool 8. In this embodiment, the tool 8 is enclosed by a cylindrical handle 13. The cylindrical handle 13 has gripping grooves 14 for the fingers of the operator. A locking plate 15 is rotatably mounted about a tool longitudinal axis 16 at the lower end of the tool 8. The locking plate 15 is rotated, for example, by means of a rotary knob 17. This detail is shown in FIG. 8.

From the view of FIG. 9 and FIG. 10 it can be identified that the locking plate 15 preferably has two eccentric plate arms 18. The plate arms 18 are dimensioned such that, in an insertion position shown in FIG. 9 and FIG. 10, they have a smaller extent in the transverse direction 5 than the transverse spacing of the inner walls 2.

In this manner, the actuator 3 can be moved with the lower face of the locking plate 15 into its actuated position which can be identified in FIG. 9 and FIG. 11. If the locking plate 15 reaches its position shown in FIG. 9 and FIG. 11, in the actuated position of the actuator 3, it can move with a pivoting movement into the recesses of the inner walls 2 and engage with its plate ends 19 of the plate arms 18 behind the undercuts 7, which is shown in FIG. 11 and FIG. 12.

As soon as the plate ends 19 of the locking plate 15 engage behind the undercuts 7, the tool 8 can be released. The tool 8 is thus securely locked in the position shown in FIG. 11 and FIG. 12 in the guide channel 1 by the restoring force exerted by the clamping limb on the actuator 3.

For the unlocking, the locking plate 15 is simply pivoted back into its initial position according to FIG. 9 and FIG. 10, so that it releases the rear engagement with the undercuts 7 again. The actuator 3 and the tool 8 can thus be moved again upwardly in the guide channel 1 and the tool 8 removed again from the guide channel 1.

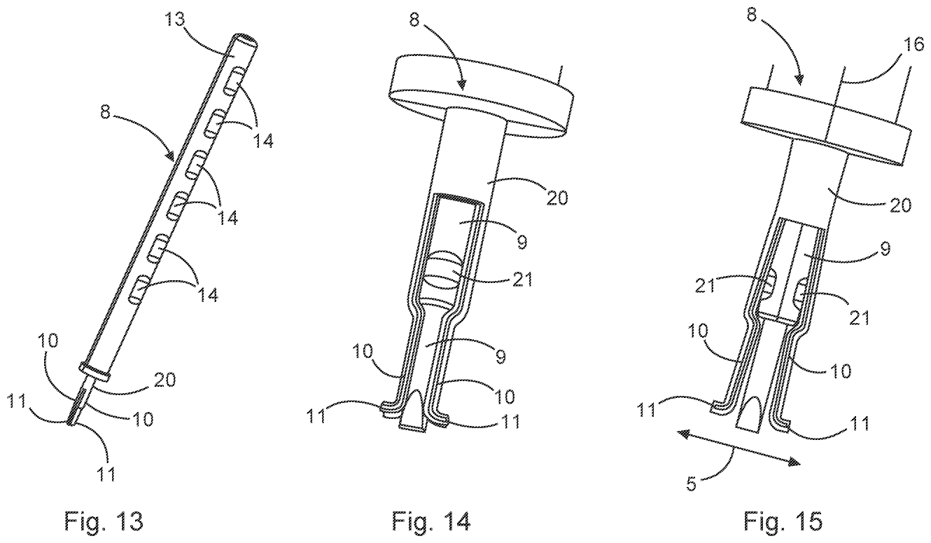

FIG. 13 shows once again a tool 8 with a handle 13. The handle 13 is cylindrical and provided with gripping grooves 14. A central lever 9 and two latching arms 10 flanking the central lever 9 on both sides are configured at the lower end of the tool 8 in FIG. 13. The latching arms 10 bear latching projections 11 at their free ends, which can be seen particularly clearly in the detailed views of FIG. 14 and FIG. 15.

The free end of the lever 9 tapers in the manner of a screwdriver blade. This design is suitable in all embodiments with a lever 9 for acting on a tool driving means which is configured as a screw slot in the top surface of the actuator 3. In the functional position shown in FIG. 14 the latching arms 10 bear closely against the lever 9, similar to the view in FIG. 4. Thus the tool 8 can be pushed in a simple manner into the guide channel 1. As soon as the screwdriver blade-like end of the lever 9 engages in the slotted tool driving means 12 on the actuator 3, the actuator 3 can be displaced in the longitudinal direction 4 into its actuated position.

In the exemplary embodiment in FIG. 13, FIG. 14 and FIG. 15 the latching arms 10 are cut free from a bearing sleeve 20. The lever 9 is rotatably mounted in the bearing sleeve 20. In this manner it is possible that expansion cams 21, which are fixed to the outer lateral surface of the lever 9, are rotated from their position shown in FIG. 14, in addition to the spring arms 10′, into a position shown in FIG. 15 in which the expansion cams 21 in each case engage below the latching arms 10. The latching arms 10 are spread apart in the transverse direction 5 by this engagement below the latching arms, which is shown in FIG. 15.

In this variant with the lever 9, which is rotatable about the tool longitudinal axis 16, with the expansion cams 21, the tool 8 can be inserted in turn into the guide channel 1 of the insulating housing, in the functional position shown in FIG. 14 with the latching arms 10 bearing closely against the lever 9, similar to the example of FIG. 4. As soon as the actuator 3 has reached the actuated position shown in FIG. 5, the expansion cams 21 are rotated behind the latching arms 10 so that the latching arms 10 according to the view in FIG. 15 are spread apart, with the result that the latching projections 11 in turn can move into the recesses with the undercuts 7.

If the tool 8 is released, the restoring force of the actuator 3 brings about a fixed bearing of the latching projections 11 on the undercuts 7 and thus locks the tool 8, shown in FIG. 13, FIG. 14 and FIG. 15, securely in the guide groove 1 of the insulating housing.

For releasing the tool 8, the expansion cams 21 with the rotatable lever 9 are rotated back again into their original position shown in FIG. 14, so that the spring arms 10′ pivot back again into their initial position shown in FIG. 14. The tool 8 can then be pulled out of the guide channel 1 again.

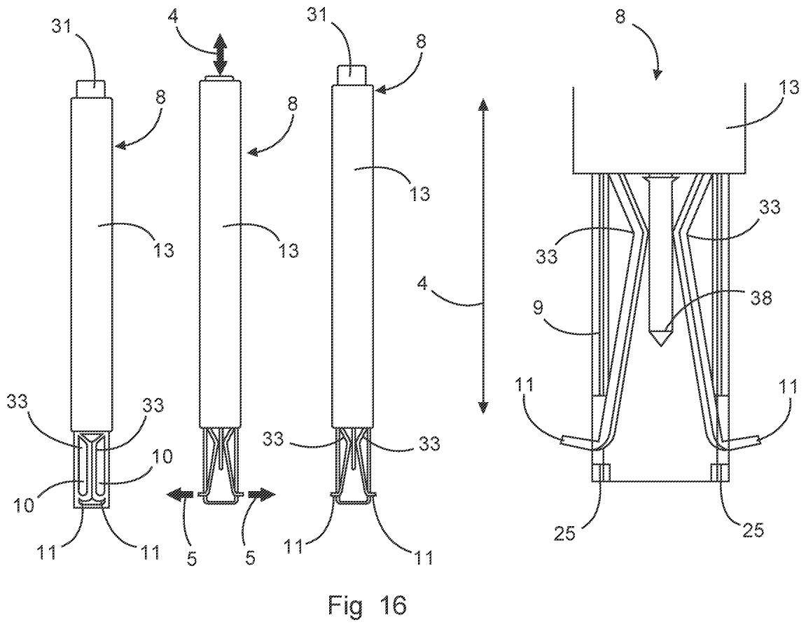

FIG. 16 shows a modification of the embodiment of the tool shown in FIG. 13, FIG. 14 and FIG. 15. The lever 9 is designed as a hollow body protruding beyond the handle 13, for example a hollow cylinder, with a lever end 25 which forms the drive element for the actuator 3. Recesses are provided in the wall of the lever 9 forming the hollow body, the latching projections 11 ultimately emerging from the wall through said recesses and being able to engage in undercuts 7 of the inner wall 2.

In the unactuated initial position of the latching arms 10, shown to the left in FIG. 16, the lower ends of the latching arms 10 bear against one another with the latching projections 11. At some distance from the latching projections 11 in the longitudinal direction, in each case both latching arms 10 are cranked outwardly in the transverse direction 5. In the handle 13, the latching arms 10 are cranked again and run with a transverse spacing in the longitudinal direction 4 through the handle 13.

A rod 38 which is mounted so as to be displaceable in the longitudinal direction 4, which is designed as a cylindrical pin and which terminates at a button 31 which can be moved in the longitudinal direction 4, runs in the handle 13 as an expansion drive for the latching arms 10.

If, from the unactuated initial position of the latching arms 10 shown to the left in FIG. 16, the button 31 is pushed downwardly in the longitudinal direction 4, which the second view from the left in FIG. 16 shows, the rod 38 moves through the cranked portions 33 and the adjoining regions of the latching arms 10 initially bearing against one another. The cranked portions 33 facing one another have the same effect as the expansion cams 21 in the exemplary embodiment of the tool described above by way of FIG. 13, FIG. 14 and FIG. 15. If the rod 38 moves downwardly in the longitudinal direction 4, the rod 38 engages below the cranked portions 33 and spreads apart the cranked portions 33 and the lower ends of the latching arms 10 adjoining thereto in the longitudinal direction 4 with the latching projections 11 in the transverse direction 5. This can be very clearly identified in the right-hand part of FIG. 16. It is also shown here that the latching projections 11 at the ends of the spread-apart latching arms 10 move into the recesses with the undercuts 7.

If the button 31 is released, a known pressure mechanism of a ballpoint pen, not described here in detail, acts such that the button 31 moves at least partially back into its initial position, which the second view from the right in FIG. 16 shows. The fixing of the rod 38, which is known from the analogy with a ballpoint pen and which can be understood as similar to a refill of the ballpoint pen, in the extended position brings about a fixed bearing of the latching projections 11 against the undercuts 7 and thus locks the tool 8 securely in the guide groove 1 of the insulating housing.

For releasing the tool 8, the button 31 is pushed again in the longitudinal direction 4. The rod 38 then pulls back into its unactuated initial position, shown to the left in FIG. 16. The rod 38 which engages below the cranked portions 33 is released again so that the spring arms 10′ pivot back into their initial position, shown to the left in FIG. 16, in which their ends with the latching projections 11 bear against one another again. The tool 8 can then be pulled back again out of the guide channel 1, whereby the lever end 25 which moves in the longitudinal direction 4 also allows the actuator 3 to return to its initial position.

In FIG. 16 the movement of the rod 38 is schematically shown disproportionally larger than the distance of the actuation of the button 31. The movement of the rod 38 in the longitudinal direction is directly coupled to the movement of the button 31 in a mechanically simple and thus preferred manner, so that the rod 38 is displaced by the same distance as the button 31.

In other embodiments, the rod 38 can also act as a drive element of the actuator 3 so that a separate lever 9 is not required. To this end, at least in the actuated position which is shown in FIG. 16 in the second view from the left, it is advantageous if the rod 38 protrudes over the spring arms 10′ or the latching projections 11 in the longitudinal direction 4. In a simple case, this can be achieved mechanically, in that the rod 38 is not fully retracted behind the cranked portions 33 of the latching arms 10 in the unactuated initial position, shown to the left in FIG. 16. The expansion drive can be implemented by a thickening of the rod 38 in the appropriate region of the cranked portions 33.

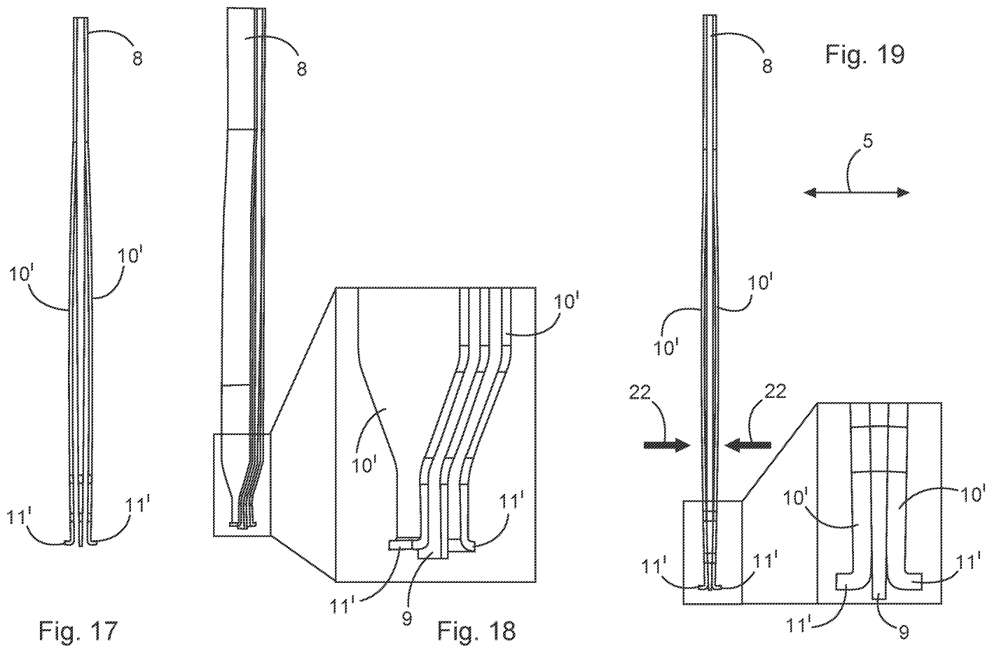

FIG. 17, FIGS. 18 and 19 show an embodiment of the tool 8 configured in the manner of tweezers. In the embodiment of FIG. 17, FIG. 18 and FIG. 19 the rigid lever 9 can be identified once again. The rigid lever 9 is flanked on both sides by two latching arms 10 which are configured as spring arms 10′. This embodiment of the tool 8 is particularly simple to handle since, for insertion into the guide channel 1, the latching arms 10 which are configured as spring arms 10′ merely have to be pushed by finger force 22 in the transverse direction 5 against the lever 9, which is shown in FIG. 19.

FIG. 19 shows the functional position of the spring arms 10′ according to the example in FIG. 4, in which the tool 8 can be inserted into the guide channel 1. Immediately after the insertion of the tool 8, the spring arms 10′ can be released again since the ends of the latching projections 11 which are configured as latching hooks 11′ then slide along the inner walls 2 of the guide channel 1. As soon as the latching hooks 11′ reach the undercuts 7, with the displacement of the tool 8 in the longitudinal direction 4, the latching hooks snap into the undercuts 7 driven by the latching arms 10 which are configured as spring arms 10′, and thus form with the undercuts 7 an automatic snap connection.

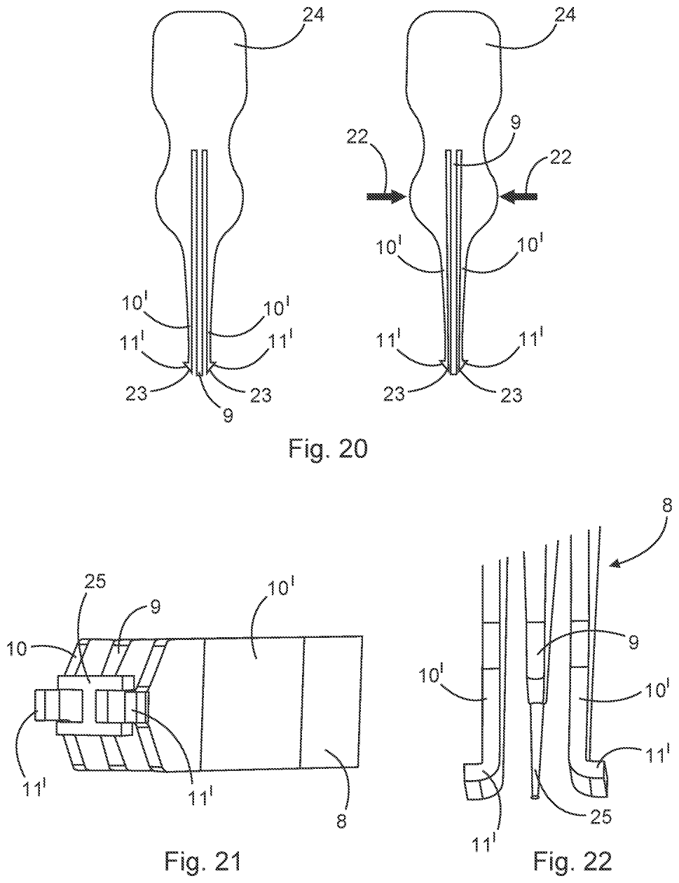

In order to promote the sliding of the latching projections 11 on the inner wall 22, in the other exemplary embodiments according to the view in FIG. 20 the latching hooks 11′ and the latching projections 11 can be provided with insertion bevels 23. In the embodiment of FIG. 20, the spring arms 10′ and the lever 9 are mounted on a central gripping plate 24 in the manner of tweezers and the latching arms 10 in turn are designed as spring arms 10′ which can be actuated by finger force 22.

FIG. 21 shows an H-shaped lever end 25. This lever end 25 can act on the tool driving means 12 of the actuator 3 by the crossbar of the H-shape. In the position of the latching arms 10 or spring arms 10′, shown in FIG. 4 and FIG. 19, the latching projections 11 or latching hooks 11′ are located between the two longitudinal bars of the H-shaped contour.

FIG. 22 finally shows an embodiment of the tool 8 with a tapering tip at the lever end 25.

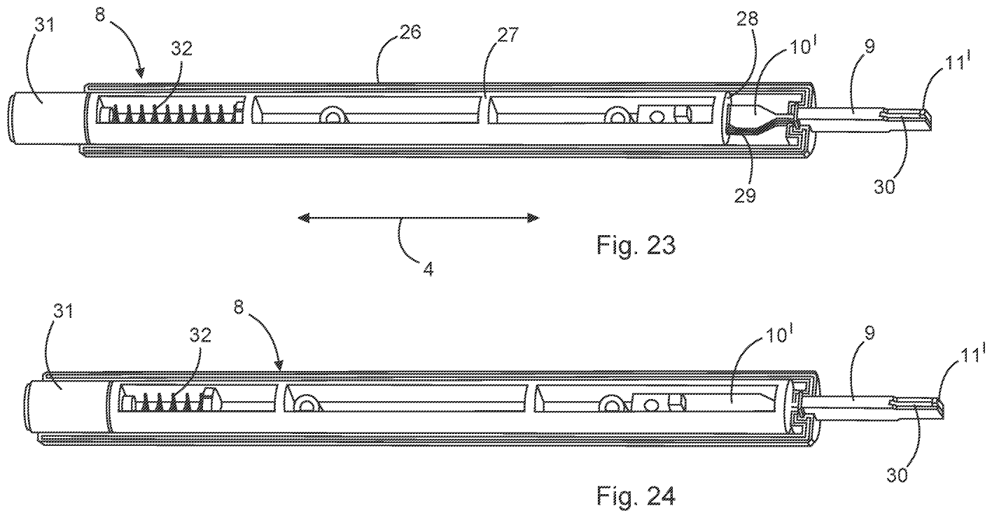

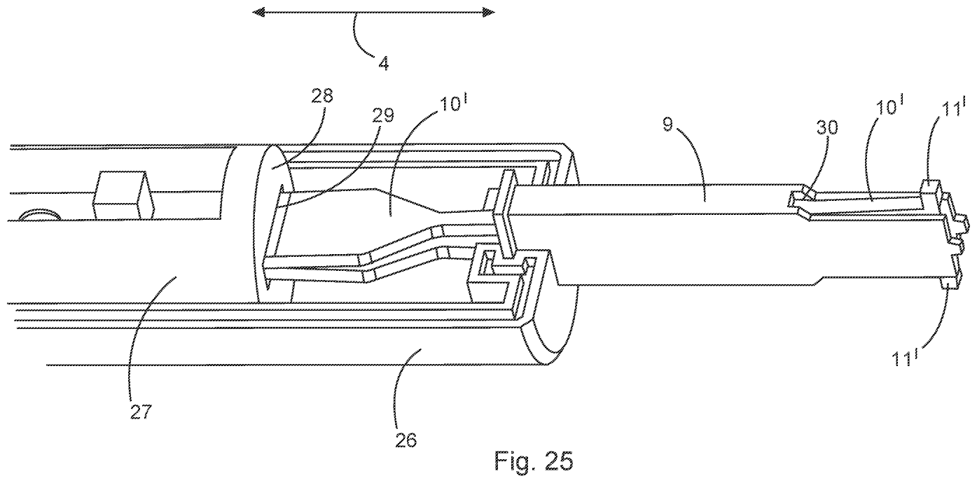

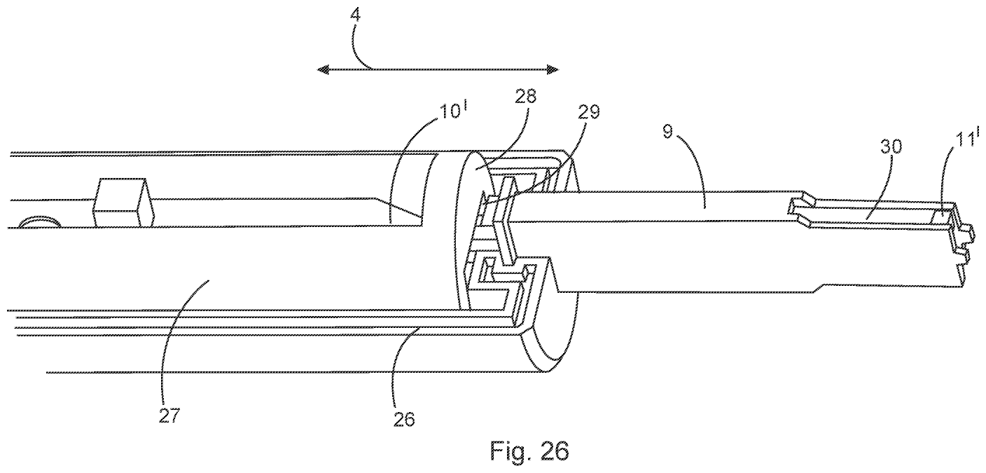

Finally, FIG. 23 and in detail FIG. 25, and FIG. 24 and in detail FIG. 26, show a further embodiment constructed in the manner of a ballpoint pen. In this embodiment, initially a handle 13 composed of two handle shells 26 is provided. FIG. 23, FIG. 24, FIG. 25 and FIG. 26 show in each case a handle shell 26, i.e. the handle 13 of the tool 8 in the open state. An unlocking sleeve 27 which is longitudinally displaceable in the longitudinal direction 4 is incorporated in the handle shell 26. The latching arms 10 are configured as spring arms 10′ similar to FIG. 17. A guide ring 28 is mounted at the end of the unlocking sleeve 27. This guide ring 28 has a slotted inner contour 29.

If the guide ring 28 is moved into its closed position in the longitudinal direction 4 in the direction of the latching projections 11 which are configured as latching hooks 11′, the spring arms 10′ are pressed against the central lever 9 and thus nestle against the lever 9 and the latching hooks 11′ move into their position in which they also bear against the lever 9, which is shown in FIG. 19, FIG. 23 and in the detail of FIG. 26.

In the exemplary embodiment of FIG. 23, FIG. 24, FIG. 25 and FIG. 26, the lever 9 is configured as a hollow profile. This hollow profile has lateral slots 30 in which the spring arms 10′ are guided with their latching hooks 11′, which can be very clearly identified in FIG. 25 and FIG. 26. When the spring arms 10′ bear against the lever 9, the latching hooks 11′ are pulled back into the slots 30 of the lever 9 which is configured as a hollow profile, so that the hollow profile in turn can be inserted into the guide channel without difficulty. This is shown in FIG. 26.

FIG. 24 and FIG. 26 also show that the unlocking sleeve 27 with the guide ring 28 and the inner contour 29 pushing the spring arms 10′ against the lever 9 are actuated by a button 31. The button 31, as shown in FIG. 24, is pushed against the spring pressure of a compression spring 32 in the direction of the lower end of the tool 8. As a result, the latching hooks 11′ move into the slots 30 of the lever 9 which is configured as a hollow profile and, similar to the view in FIG. 4, the tool 8 can be pushed again into the guide channel 1 until the end of the lever 9 strikes the top surface of the actuator 3.

If the button 31 is then released, the button 31 and therewith the unlocking sleeve 27 move back into their initial position shown in FIG. 23 and FIG. 25. In this initial position, shown in FIG. 25, the inner contour 29 of the guide ring 28 releases the spring arms 10′ in the open position of the guide ring 28. As a result of their resilient configuration, the spring arms 10′ automatically spring out into their position shown in FIG. 25 and engage behind the undercuts 7, similar to FIG. 5. If the tool 8 is fully released, it is automatically held in turn by the restoring force of the actuator 3 in the guide channel 1.

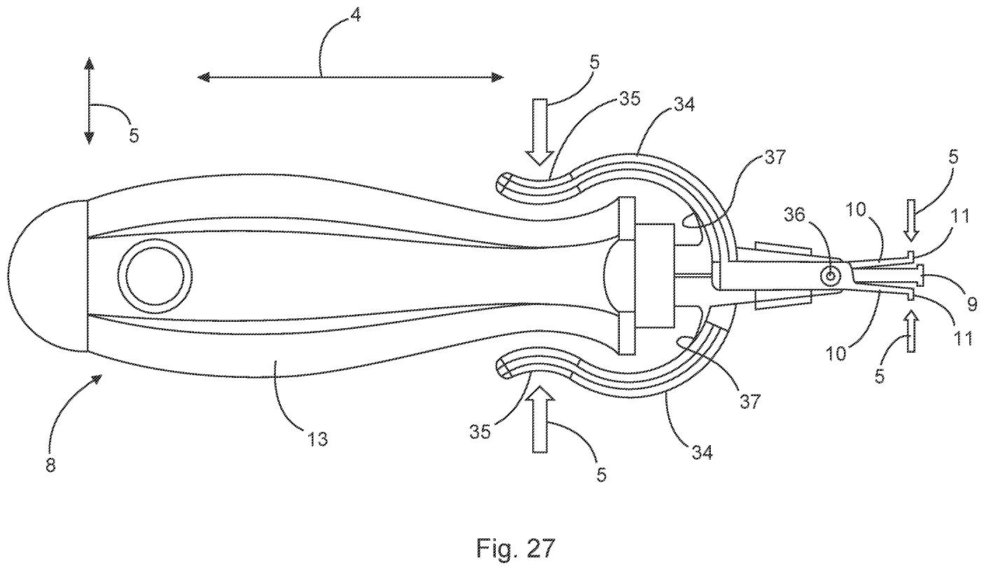

The further embodiment of the tool 8 shown in FIG. 27 has an optional knob-shaped handle 13, a central rigid lever 9 and two latching arms 10 with latching projections 11 at their free ends, in each case laterally flanking the rigid lever 9. The dimensions of the lever 9 and the latching arms 10 are adapted to one another such that in the actuated position of the actuator 3 the latching arms 10 engage with their latching projections 11 in the recesses in the inner wall 2 and thus engage behind the undercuts 7. FIG. 27 shows this functional position of the tool 8. The tool in FIG. 27 corresponds to the exemplary embodiment of FIG. 4, FIG. 5 and FIG. 6 regarding the configuration and the function of the lever 9 and the latching arms 10.

The latching arms 10 have at their ends facing away from the latching projections 11 in each case an arcuate gripping arm 34 with an opposing grip recess 35. The respective gripping arm 34 faces in the transverse direction 5, in the opposing direction of the associated latching projection 11 on the respective latching arm 10. Both latching arms 10 are mounted with a rotary joint 36 on the tool 8 and pivotably connected together via the rotary joint 36. The latching arms 10 and the rotary joint 36 form a scissors lever with one another. This scissors lever is actuated by the gripping arms 34.

Arcuate and leaf spring-like spring bodies 37 protrude from the lever 9 in the transverse direction 5. The spring bodies 37 are adapted in terms of their arcuate shape to the arcuate shape of the gripping arms 34, such that the spring bodies 37 nestle with their outer wall against the gripping arms 34 from the inside. FIG. 27 shows the position of the latching arms 10 before insertion into the guide channel 1 or in the position of the latching projections 11 engaged behind the undercuts 7.

If the tool is to be inserted into the guide channel 1 or the engagement of the latching projections 11 behind the undercuts 7 is to be released, the gripping arms 34 are pivoted toward one another in the transverse direction 5 counter to the spring pressure of the leaf spring-like spring bodies 37, whereby the latching arms 10 can also be moved toward one another in the transverse direction 5 until they bear flush against the lever 9, which is shown for example in FIG. 4. The thumb and the index finger of the operator thus grip in the grip recesses 35. The manner of operation of this embodiment of the tool 8 is similar to that of scissors or pliers.

In this position with the gripping arms 34 and latching arms 10 moved toward one another in the transverse direction 5, the tool can be moved to and fro in the longitudinal direction 4 in the guide channel 1 out of the unloaded position of the actuator 3 into its actuated position or out of the actuated position of the actuator 3 into its unloaded position. If the operator releases their grip from the gripping arms 34, both the gripping arms 34 and the latching arms 10 are moved back automatically by the spring force of the spring bodies 37 into their initial position shown in FIG. 26.

The external appearances of the tool 8 which are shown are to be considered as merely schematic and by way of example, and this relates in particular to the embodiment with the cylindrical handle 13 with the gripping grooves 14. The functional embodiments of the tool 8, for which no corresponding handle 13 is shown, can obviously also be combined with corresponding features from other embodiments.

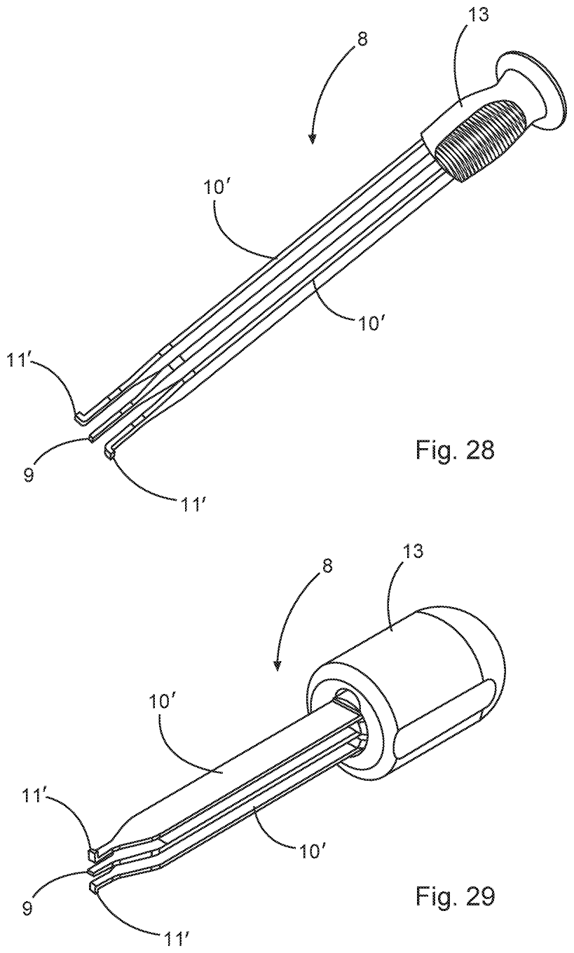

FIGS. 28 and 29 show further embodiments of a tool 8 which is configured as in FIG. 17 in the manner of tweezers. For improving the ergonomics of the handling, the tools 8 of FIGS. 28 and 29 have in each case a handle 13 on the rigid lever 9 and the end facing away from the spring arms 10′.

### LIST OF REFERENCE SIGNS

1 Guide channel
2 Inner wall
3 Actuator
4 Longitudinal direction
5 Transverse direction
6 Constriction
7 Undercut
8 Tool
9 Lever
10 Latching arm, 10′ spring arm
11 Latching projection, 11′ latching hook
12 Tool driving means
13 Handle
14 Gripping groove
15 Locking plate
16 Tool longitudinal axis
17 Rotary knob
18 Plate arm
19 Plate end
20 Bearing sleeve
21 Expansion cams
22 Finger force
23 Insertion bevel
24 Gripping plate
25 Lever end
26 Handle shell
27 Unlocking sleeve
28 Guide ring
29 Inner contour
30 Slot
31 Button
32 Compression spring
33 Cranked portion
34 Gripping arm
35 Grip recess
36 Rotary joint
37 Spring body
38 Rod

1.-15. (canceled)

16. A tool (8) for locking an actuator (3) which is longitudinally movable, counter to a spring pressure of a spring element, in a guide channel (1) of an insulating housing between an unloaded and an actuated position, the tool comprising:
means for releasably fastening the tool (8) to the insulating housing;
a drive element for moving the actuator (3) into an actuated position;
means for locking the actuator (3) in the actuated position; and
force-generating means configured to apply a force required for fastening the means for releasable fastening in the insulating housing.

17. The tool (8) as claimed in claim 16,
wherein the force-generating means permit a deformation, clamping or pivoting of at least one part of the tool (8) comprising the means for releasable fastening.

18. The tool (8) as claimed in claim 16,
wherein the actuator (3) is locked by the drive element in the actuated position when the tool (8) is fastened to the insulating housing.

19. The tool (8) as claimed in claim 16,
wherein the means for releasably fixing the tool (8) to the insulating housing comprises a rear engagement of the tool (8) on the insulating housing.

20. The tool (8) as claimed in claim 19, further comprising
an undercut (7) on an inner wall (2) of the guide channel (1), and
a rear engagement part (11, 19) on the tool (8) engaging behind the undercut (7) in the actuated position of the actuator (3).

21. The tool (8) as claimed in claim 20,
wherein the force-generating means comprise a locking plate (15) which is rotatable about a tool longitudinal axis (16), with plate ends (19) engaging behind the undercut (7) in the guide channel (1) in the actuated position of the actuator (3).

22. The tool (8) as claimed in claim 20,
wherein the drive element is a rigid lever (9) extending in a direction of a tool longitudinal axis (16), and
wherein the tool further comprises two opposing latching arms (10) with latching projections (11) at their free ends, the two opposing latching arms (10) flanking the lever (9) on both sides and being movable transversely to the tool longitudinal axis (16).

23. The tool (8) as claimed in claim 22,
wherein the latching arms (10) are configured as spring arms (10′) which are resilient transversely to the tool longitudinal axis (16) with latching projections (11) configured as latching hooks (11′).

24. The tool (8) as claimed in claim 23,
wherein ends of the latching hooks (11′) facing away from the spring arms (10′) are formed as insertion bevels (23).

25. The tool (8) as claimed in claim 23, further comprising
a guide ring (28) which can be moved along outer surfaces of the spring arms (10′) in the direction of the latching hooks (11′) and which has an inner contour (29) as a means for force guidance which acts on the outer surfaces of the spring arms (10′), such that
in an open position of the guide ring (28) remote from the latching hooks (11′) the spring arms (10′) spring out and
in a closed position of the guide ring (28) which is moved in the direction of the latching hooks (11′) the spring arms spring in and bear against the lever (9).

26. The tool (8) as claimed in claim 25,
wherein the guide ring (28) is a constituent part of a longitudinally displaceable unlocking sleeve (27) which is embedded in a hollow handle (13),
wherein the tool (8) with the guide ring (28) is mounted at a lower end of the handle (13) and
wherein at an opposing upper end of the hollow handle (13) a button (31) which is kinematically coupled to the unlocking sleeve (27) protrudes from the hollow handle (13), such that by pushing on the button (31) counter to the spring pressure of a compression spring (32) the unlocking sleeve (27) can be moved out of the open position of the guide ring (28) into the closed position of the guide ring (28).

27. The tool (8) as claimed in claim 22,
wherein the force-generating means include a rotatable lever (9) with two opposing expansion cams (21) on its outer lateral surface as an expansion drive for the latching arms (10).

28. The tool (8) as claimed in claim 22,
further comprising latching arms (10) with two opposing cranked portions (33) and a longitudinally displaceable rod (38) as an expansion drive for the latching arms (10).

29. The tool (8) as claimed in claim 22,
further comprising two latching arms (10) which are connected via a rotary joint (36) so as to be pivotable in opposing directions and
wherein two latching arms (10) each have a gripping arm (34) at their free ends facing away from the latching projections (11) for forming a scissors lever as a drive for the latching arms (10).

30. A cable connection device, comprising:
the tool as claimed in claim 16; and
an insulating housing for a cable connection device with a wire insertion opening;
a contact carrier with a conductor rail arranged in the wire insertion opening;
a clamping limb of a contact spring which applies spring pressure to the conductor rail;
a guide channel (1) for an actuator (3) which is longitudinally displaceable counter to the spring pressure of the clamping limb between an unloaded and an actuated position for closing and opening a spring contact; and
at least one undercut (7) on an inner wall (2) of the guide channel (1).
